(19) United States
(12) Patent Application Publication
(10) Pub. No.: US 2015/0051518 A1
(43) Pub. Date: Feb. 19, 2015

(54) ELECTROMAGNETIC POWERED SPUTUM EXCRETION SYSTEM

(71) Applicants: Zhenghui Zhou, Nanjing (CN); Zhi Zhong, Changshu (CN); Shaodan Han, Changshu (CN); Yuxu Zhao, Changshu (CN); Jinchao Yan, Changshu (CN)

(72) Inventors: Zhenghui Zhou, Nanjing (CN); Zhi Zhong, Changshu (CN); Shaodan Han, Changshu (CN); Yuxu Zhao, Changshu (CN); Jinchao Yan, Changshu (CN)

(73) Assignee: Boyu Medical Electronics (Changshu)Ltd, Changshu (CN)

(21) Appl. No.: 14/387,846

(22) PCT Filed: May 21, 2012
(86) PCT No.: PCT/CN2012/075799

§ 371 Date: Sep. 25, 2014

(30) Foreign Application Priority Data
Mar. 28, 2012 (CN) 201210086463.5
Mar. 28, 2012 (CN) 201210086464.X
Mar. 28, 2012 (CN) 201210086533.7
Mar. 28, 2012 (CN) 201220123167.3
Mar. 28, 2012 (CN) 201220123168.8
Mar. 28, 2012 (CN) 201220123170.5
May 21, 2012 (IB) PCTCN2012075799

(51) Int. Cl. A61H 23/02; A61H 9/00; A61H 23/04; A61H 1/00

(52) U.S. Cl. CPC A61H 23/02; A61H 1/00; A61H 9/0071; A61H 23/04; A61H 2205/084; A61H 2201/5007; A61H 2201/5058; A61H 2031/025
USPC 601/18

(57) ABSTRACT

An electromagnetic powered sputum excretion system comprises a coughing sensor, a frequency input end, an air pressure input end, an electric-controlled switch, a timing input end, a pressure vest (80), an air vibration device (90), and a fan (70). The air is extruded by attracting iron clappers (904) with an electromagnet (906) to generate a vibrating airflow, and the chest of a patient is vibrated by the action on the chest of the patient through the pressure vest (80), thereby the sputum excretion system assists the patient to excrete sputum. Since the control via the electromagnet (906) is characterized by promptness, stability, low energy consumption and the like, the sputum excretion system, which utilizes the electromagnet (906) as a power to generate the vibrating airflow, has above characteristics as well. The present sputum excretion system further has the advantages of simple operation and low cost.

### CROSS-REFERENCE TO RELATED APPLICATION

This application is the U.S. national phase of International Application No. PCT/CN2012/075799, filed on May 21, 2012, which claims benefit of Chinese application 201210086533.7, flied Mar. 28, 2012, Chinese application 201220123170.5, flied Mar. 28, 2012, Chinese application 201210086464.X, flied Mar. 28, 2012, Chinese application 201220123168.8, flied Mar. 28, 2012, Chinese application 201210086463.5, flied Mar. 28, 2012 and Chinese application 201220123167.3, flied Mar. 28, 2012. The entire contents of which is hereby incorporated by reference.

### BACKGROUND OF THE INVENTION

1. Field of the Invention

The present invention relates to an electromagnetic powered sputum excretion system.

2. Background of the Invention

Chest physical therapy has a long history of clinical applications. It is very effective, and is among the standard of medical methods for improving airway mucus cleanup in various countries. The chest physical therapy comprises manual knocking on the back for sputum excretion, in vitro vibration machine for sputum excretion, but all of these suffer from many problems.

In recent years, vest type air pulse sputum excretion devices have also been developed and improved in foreign countries. The air pressure pulse machine repeatedly deflates and inflates two airbags which are fixed in front of the vest. Each application of pressure will force the air flow to quickly pass through the lobe, and promote the secretion of debris to fall from the lung wall and move to the oral cavity. Once the secretion of debris reaches the oral cavity, it can be discharged through the normal cough or vacuum suction. In this sputum excretion device, the operation is fully automated, and the standard parameter setting is adopted, which substantially overcomes drawbacks of the two methods mentioned in the previous paragraph. However, new problems are introduced as follow. Firstly, the fixed two-point anterior chest wall pulse can not beat the side and back of the thorax, and the effect of sputum excretion is poor for some patients. Secondly, once the treatment parameters have been set, the therapeutic procedure is performed in light of the standards completely, and is not interrupted even if it has induced the patient to cough, which may lead to risks like continuous coughing for a long time, consuming a lot of physical strength, and hyperventilation. In view of these problems, a new “intelligent all-chest high frequency vibration sputum excretion device” has been developed, which is described as follow.

As shown in FIG. 1, the intelligent all-chest high frequency vibration sputum excretion device comprises a hose 1, a coughing sensor 3, a wire 4, a housing 6, a cover plate 7, a pressure vest 8, a frequency input end 22, an air pressure input end 23, an electric-controlled switch 26, and a timing input end 30. The hose 1 connects the pressure vest 8 with an air vibration device 9 in the housing 6. A pressure sensor 2 is installed at one end of the wire 4, and the other end of the wire 4 is connected with the air vibration device 9. The frequency input end 22, the air pressure input end 23, the electric-controlled switch 26, and the timing input end 30 are installed on the cover plate 7 respectively. As shown in FIGS. 2-3, the pressure vest 8 comprises a metal spring coil 10, a lateral diaphragm 11, a longitudinal diaphragm 12, a skin part 13, and linking tapes 14. The upper end of the longitudinal diaphragm 12 is connected with the skin part 13. The longitudinal diaphragm 12 divides the space within the skin part 13 into longitudinal air chambers 25. The lower end within the skin part 13 is provided with the metal spring coil 10. The lateral diaphragm 11 is installed over the metal spring coil 10. A air hole 24 is arranged within the lateral diaphragm 11. Linking tapes 14 are installed at both sides of the skin part 13. As shown in FIG. 4, the air vibration device 9 comprises a frequency voltage conversion circuit 15, a pulse regulator 16, an air pressure pulse regulator 17, an air pressure detection circuit 18, a power amplifier 19, an electric motor 20, and an air pressure compensator 21. The pressure sensor 2 detects a pressure signal and sends it to the frequency voltage conversion circuit 15. The converted signal is sent to the pulse regulator 16, in which the signal is regulated and then sent to the electric motor 20. At the same time, the pressure sensor 2 is connected with the air pressure detection circuit 18 as an input end thereof The signal produced in the air pressure detection circuit 18 is sent to the air pressure pulse regulator 17, in which the signal is analytically regulated and then sent to the air pressure compensator 21. The air pressure compensator 21 is connected with the electric motor 20, and the output end of the electric motor 20 is connected with the hose 1. The coughing sensor 3 is connected with the power amplifier 19 as an input end thereof The amplified signal is sent to the electric-controlled switch 26. The timing input end 30 is connected with a timing device 29, an output end of which is connected with the electric motor 20. A power supply unit 5 adopts alternating 220V. The longitudinal diaphragm 12 and the lateral diaphragm 11 divide the inside space of the skin part 13 into 14 longitudinal air chambers 25.

By adopting this intelligent all-chest high frequency vibration sputum excretion device, the sputum excretion method comprises the steps of:

a. fixing the pressure vest 8 to human chest 28 via linking tapes 14;

b. according to the user's conditions, regulating the frequency input end 22, the air pressure input end 23, and the timing input end 30 on the cover plate 7, and then turning on the electric-controlled switch 26;

c. making the electric motor 20 to transfer air to the pressure vest 8 according to a preset value;

d. importing air to inflate the pressure vest 8 for massaging the human chest 28, while detecting by the pressure sensor 2 the signal of pressure that the pressure vest 8 acts on the human chest 28;

e. comparing the detected pressure signal with the preset value, and then sending the signal to the air the pressure pulse regulator 17 and the pulse regulator 16 for regulating;

f. sending the regulated signal to the electric motor 20 and the air pressure compensator 21, so that the electric motor 20 transfers air to the pressure vest 8 according to the compensated signal;

e. stopping transferring the air if the coughing sensor 3 has detected a chest vibration frequency ≧3 times/10 seconds or the massaging last a time preset by the timing device, otherwise continuing to transfer the air.

During use, the pressure vest 8 is bound around the human chest 28, and the pressure vest 8 is arranged to closely bind the human chest via linking tapes 14. According to the user's conditions, the frequency input end 22, the air pressure input end 23, and the timing input end 30 are adjusted, and then the electric-controlled switch 26 is turned on. As a result, the electric motor 20 transfer air into the pressure vest 8 periodically via the hose 1 according to the set values. At the same time, the pressure sensor 2 and the coughing sensor 3 monitors the system in real time as follow.

1) When the pressure sensor 2 detects that the pressure of the pressure vest 8 does not match the preset pressure, the pressure sensor 2 sends a signal to the frequency voltage conversion circuit 15, so that the frequency voltage conversion circuit 15 transfers a signal to the pulse regulator 16. The pulse regulator 16 regulates the signal appropriately, and controls the electric motor 20 to transfer air to the pressure vest 8 connected with the hose 1. When the pressure sensor 2 detects the pressure signal matches the preset value, the pulse regulator 16 stops regulating, and the electric motor 20 transfer air to the hose 1 according to the current state.

2) When the pressure sensor 2 detects the peak air pressure in the longitudinal air chambers 25 does no match the preset value of the air pressure detection circuit 18, the air pressure detection circuit 18 transfer a signal to the air pressure pulse regulator 17. The regulated signal is sent to the air pressure compensator 21, and a certain amount of air is transferred to the electric motor 20 via the air pressure compensator 21, so that the air is supplemented to the hose 1.

3) When the coughing sensor 3 detects coughing information from the user, namely, when continuous coughing (≧3 times/10 seconds) occurs, the coughing sensor 3 sends a signal to the power amplifier 19. The amplified signal controls the electric-controlled switch 26 to perform power-off control, so that the electric motor 20 stops transferring air to the pressure vest 8.

When the pressure vest 8 receives the air input by the electric motor 20, the air firstly fills the metal spring coil 10, and partially flows into longitudinal air chambers 25 through the air hole 24. Due to the variation in the air flow transferred by the electric motor 20, the air in the longitudinal air chambers 25 will be discharged from the pressure vest 8 through the air hole 27 to different extent. By changing the air within the longitudinal air chambers 25, an effect of massaging the chest is realized.

The above scheme is a good solution to the conventional problems. However, it is complicated to control the air vibration device 9 comprising the frequency voltage conversion circuit 15, the pulse regulator 16, the air pressure pulse regulator 17, the air pressure detection circuit 18, the power amplifier 19, the electric motor 20, and the air pressure compensator 21. Besides, the air pressure compensator 21 is also realized by an electric motor, so that the whole system is slow in response and consumes significant electricity. During the process of sputum excretion, the patient or an accompanying person is required to act as a guardian. Thus, there is a need for developing a new air vibrating device.

### BRIEF SUMMARY OF THE INVENTION

In view of the problems mentioned above, the present invention proposes an electromagnetic powered sputum excretion system. The technical solution of the present invention is realized as follow.

An electromagnetic powered sputum excretion system comprising: a coughing sensor, a frequency input end, an air pressure input end, an electric-controlled switch, a timing input end, a pressure vest, an air vibration device, and a fan;

characterized in that said air vibration device comprises a stainless steel belt II, iron clappers, a housing seat, an electromagnet, and fixing bolts;

said electromagnet is fixed within an accommodating chamber in the housing seat; the iron clappers are fixed onto the housing seat via a stainless steel belt II, the iron clappers and the accommodating chamber enclose a sealed space, and a deformation zone of the iron clappers are located at a position corresponding to that of the electromagnet; an air inlet and an air outlet are arranged at the position of the accommodating chamber of said housing seat, said air inlet is connected with the fan, and said air outlet is connected with the pressure vest via a hose.

Said iron clappers are sleeved in a rubber gasbag, which is fixed onto the housing seat via a stainless steel belt I.

The present invention has the following obvious advantages. The air is extruded by attracting the iron clappers with the electromagnet to generate a vibrating airflow, and the chest of a patient is vibrated by the action on the chest of the patient through the pressure vest, thereby the sputum excretion system assists the patient to excrete sputum. Since the control via the electromagnet is characterized by promptness, stability, low energy consumption and the like, the sputum excretion device, which utilizes the electromagnet as a power to generate the vibrating airflow, has above characteristics as well. The present electromagnetic powered sputum excretion system further has the advantages of simple operation and low cost, so that it can be widely applied in the field of new sputum excretion device.

In view of the problems mentioned above, the present invention proposes an electromagnetic powered sputum excretion system, which comprises a coughing sensor, a frequency input end, an air pressure input end, an electric-controlled switch, a timing input end, a pressure vest, an air vibration device, and a fan;

wherein said air vibration device comprises a stainless steel belt II, iron clappers, a housing seat, an electromagnet, and fixing bolts;

said electromagnet is fixed within an accommodating chamber in the housing seat; the iron clappers are fixed onto the housing seat via a stainless steel belt II, the iron clappers and the accommodating chamber enclose a sealed space, and a deformation zone of the iron clappers are located at a position corresponding to that of the electromagnet; an air inlet and an air outlet are arranged at the position of the accommodating chamber of said housing seat, said air inlet is connected with the fan, and said air outlet is connected with the pressure vest via a hose.

Said iron clappers are sleeved in a rubber gasbag, which is fixed onto the housing seat via a stainless steel belt I.

The sputum excretion system further comprises:

a storage unit, in which a plurality of sputum excretion plans including the start time and stop time of the sputum excretion system, the extrusion dynamics and intervals of excretion actions of the sputum excretion system are stored in advance;

a control unit, which is connected with the storage unit (601), and selects a specific sputum excretion plan as needed; or directly controls the start time and stop time of the sputum excretion system, the extrusion dynamics and intervals of excretion actions of the sputum excretion device;

a central processing unit, which is connected with said control unit (603), executes the selected sputum excretion plan, controls start and stop of the sputum excretion system, controls the extrusion dynamics and intervals of excretion actions of the sputum excretion system in the process of sputum excretion.

The sputum excretion system further comprises an input and edit unit, which is connected with the storage unit, inputs a new sputum excretion plan, edits the original sputum excretion plan, and sets a specific sputum excretion plan as a default sputum excretion plan. The sputum excretion system further comprises a display unit, which displays information about the sputum excretion plan being executed by the sputum excretion device, the remaining time of the current sputum excretion, the time for the next sputum excretion, the extrusion dynamics and intervals of excretion actions of the sputum excretion device.

The sputum excretion system further comprises a learn and record unit, which records the process of sputum excretion in a day, and stores it as a new sputum excretion plan.

The present invention has the following obvious advantages. The air is extruded by attracting the iron clappers with the electromagnet to generate a vibrating airflow, and the chest of a patient is vibrated by the action on the chest of the patient through the pressure vest, thereby the sputum excretion system assists the patient to excrete sputum. Since the control via the electromagnet is characterized by promptness, stability, low energy consumption and the like, the sputum excretion device, which utilizes the electromagnet as a power to generate the vibrating airflow, has above characteristics as well. According to the present electromagnetic powered sputum excretion system, sputum excretion schemes are stored in advance. Such a sputum excretion device further has the advantages of simple operation and low cost, so that it can be widely applied in the field of new sputum excretion device.

### BRIEF DESCRIPTION OF THE DRAWINGS

In order to describe embodiments of the present invention or technical solutions in the prior art more clearly, accompanying drawings in relation to these embodiment of the prior art will be described briefly. It is apparent that the following drawings only aim to illustrate some embodiments of the present invention, and that other drawings can be obtained from these drawings for the ordinary skilled in the art without any inventive work.

FIG. 1 is a schematic diagram showing hardware construction of a sputum excretion device of the prior art;

FIG. 2 is a structural diagram showing a pressure vest in a sputum excretion device of the prior art;

FIG. 3 is a diagram showing operating principle of a pressure vest in a sputum excretion device of the prior art;

FIG. 4 is a circuit diagram showing an air vibration device in a sputum excretion device of the prior art;

FIG. 5 is a structural diagram showing an air vibration device in a sputum excretion device of the present invention;

FIG. 6 is a structural diagram showing an air vibration device assembled in a sputum excretion device of the present invention;

FIG. 7 is a general diagram showing an air vibration device in a sputum excretion device of the present invention;

FIG. 8 is a structural diagram showing an electric control portion of the present invention.

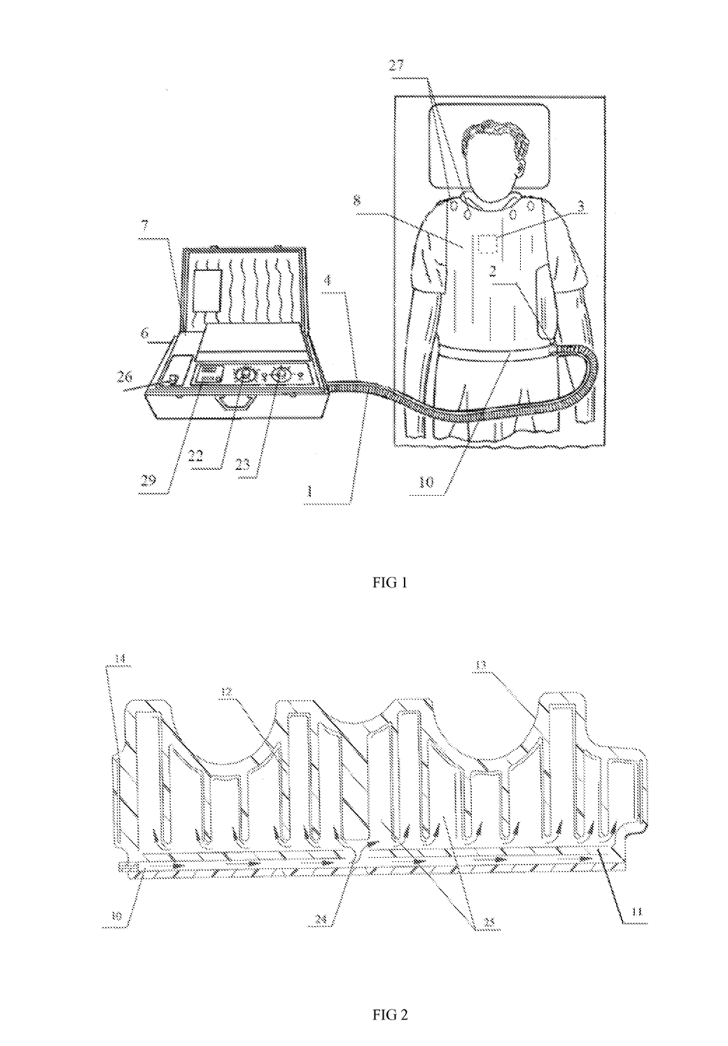

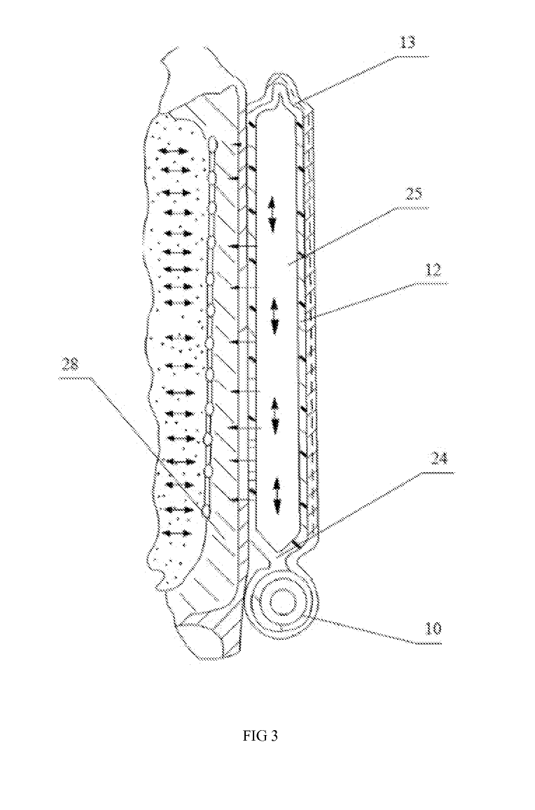

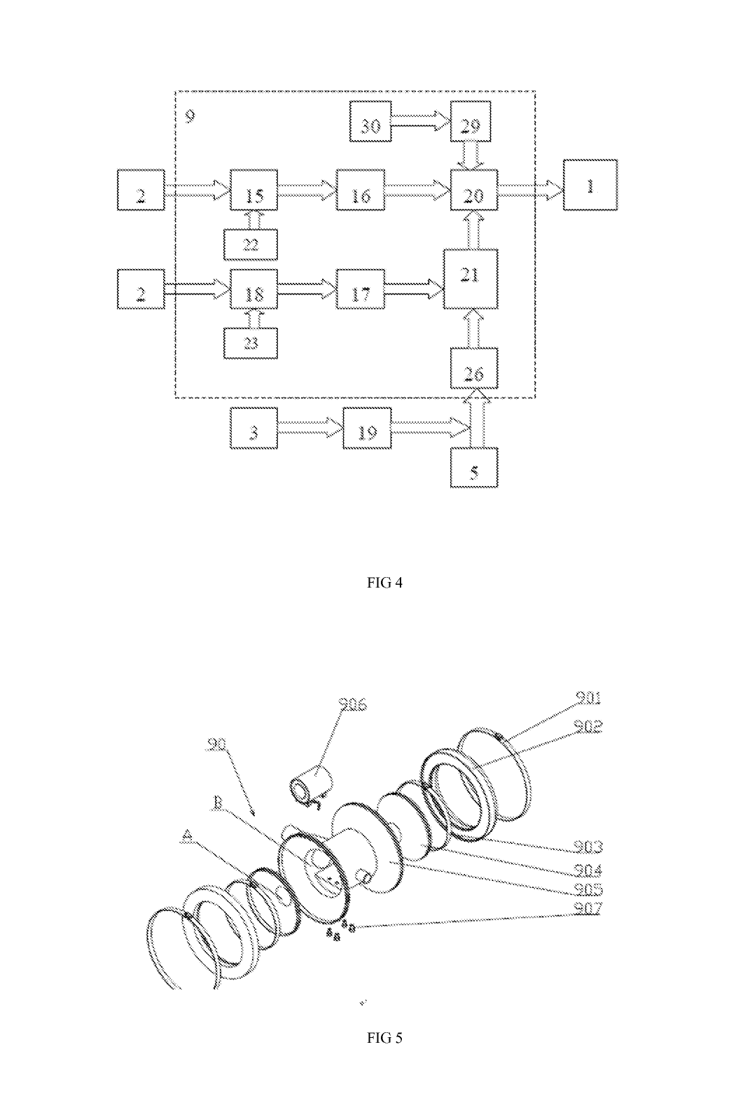

### DETAILED DESCRIPTION OF THE EMBODIMENTS

In order to make objects, solutions, and advantages of embodiments of the present invention more clear, the technical solutions in embodiments the present invention will be described hereinafter in a clear and comprehensive manner by referring to drawings of embodiments of the present invention. It is obvious that the described embodiments are only some embodiments, instead of all embodiments, of the present invention. Embodiments, which will be achieved by the ordinary skilled in the art by starting from embodiments of the present invention without inventive work, fall within the protection scope of the present invention.

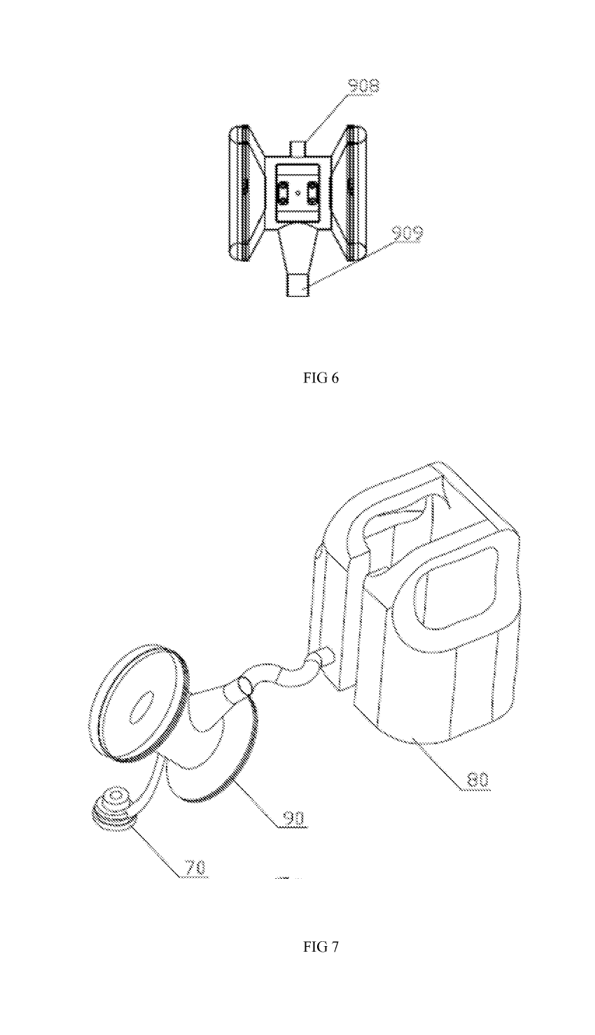

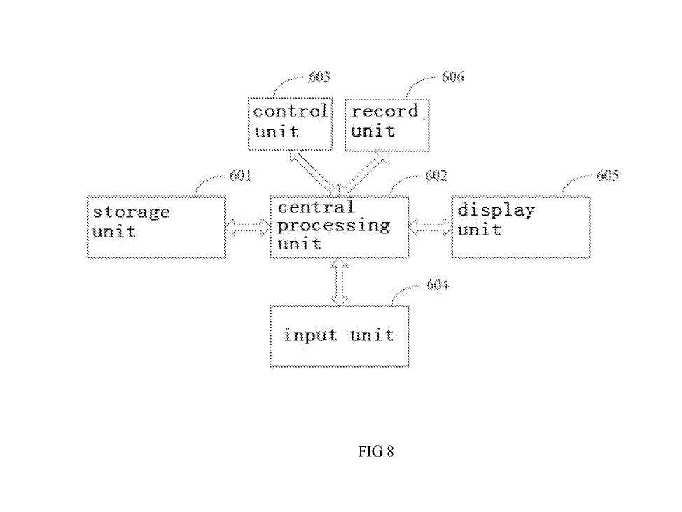

As shown in FIGS. 5-7, an electromagnetic powered sputum excretion device comprises a coughing sensor, a frequency input end, an air pressure input end, an electric-controlled switch, a timing input end, a pressure vest 80, an air vibration device 90, and a fan 70. The air vibration device 90 comprises a stainless steel belt II 903, iron clappers 904, a housing seat 905, an electromagnet 906, and fixing bolts 907. The electromagnet 906 is fixed within an accommodating chamber B in the housing seat 905 via fixing bolts 907. The iron clappers 904 are fixed onto the housing seat 905 via the stainless steel belt II 903. The iron clappers 904 and the accommodating chamber enclose a sealed space. A deformation zone A of the iron clappers 904 is located at a position corresponding to that of the electromagnet 906, so that the magnetic force produced by the electromagnet acts on the clapper, which compresses the iron clappers 904 and the air in the accommodating chamber to generate a vibrating airflow. As shown in FIG. 5, the iron clappers 904 are symmetrically arranged and mounted at both sides of the accommodating chamber B. The corresponding electromagnet 906 adopts an electromagnet which, once energized, will generate an attracting force at both sides. Once energized, the electromagnet will simultaneously attract the iron clappers 904 mounted at its both sides, and compress the air in the accommodating chamber B. An air inlet 908 and an air outlet 909 are arranged at the position of the accommodating chamber of said housing seat 905. The air inlet 908 is connected with the fan 70, and the air outlet 909 is connected with the pressure vest 80 via a hose. Said iron clappers 904 are sleeved in a rubber gasbag 902, which is fixed onto the housing seat 905 via a stainless steel belt I 901.

In the sputum excretion device, the magnetic force generated by the electromagnet acts on the clappers at both sides to compress the air, thus generating a vibrating airflow. The operating characteristic, i.e., an operation cycle, is as follow: (1) when the electromagnet is energized, a magnetic field is generated, which attracts the clappers to move to the electromagnet from the equilibrium position, thus compressing and extruding the gas in the chamber; and (2) when the electromagnet is de-energized, the magnetic field disappears, so that the clappers return to the equilibrium position due to the loss of the attracting force, thus releasing the space in the chamber and inhaling gas. With this operating characteristic, the air is vibrated, and the chest of a patient is vibrated by the action on the chest of the patient through the pressure vest, thereby the sputum excretion system assists the patient to excrete sputum.

As shown in FIG. 8, the sputum excretion system comprises a storage unit 601. A plurality of sputum excretion plans are established in advance according to clinical experience of physicians and nurses, and stored in the storage unit 601. The sputum excretion plan comprises: times of sputum excretion within a day for a certain patient, start time and stop time of each sputum excretion, the extrusion dynamics and intervals of excretion actions of the sputum excretion device. The central processing unit 602 is used to execute the selected sputum excretion plan, control the on-off of said electromagnet 906, and conduct the compressing rhythm and strength of the pressure vest 80, so as to assist the patient to excrete sputum. Before use, an appropriate control unit 603 is used to select the suitable sputum excretion plan. When the patient continues to excrete sputum, the sputum excretion device may also be started directly via the control unit 603. When it is required to temporarily stop, the sputum excretion device may also be directly controlled to stop or suspend via the control unit 603.

Although a plurality of sputum excretion plans have been stored in advance according to clinical experience of physicians, a case will still occur in which these plans are not suitable for a specific patient. Furthermore, the sputum excretion system comprises an input and edit unit 604, which can input a completely new sputum excretion plan according to the specific conditions of the patient.

Moreover, the sputum excretion system comprises a record unit 606, which can record the operating conditions of the sputum excretion device in one or more days. The operating conditions may comprise information like running times of the sputum excretion device, the start time and stop time, the extrusion dynamics and frequency of the pressure vest in a specific day. The record unit 606 can generate a new sputum excretion plan, which greatly facilitates its use by the patient.

Preferably, the present system further comprises a display unit 605, which displays information about the sputum excretion plan being executed by the sputum excretion device, the remaining time of the current sputum excretion, the time for the next sputum excretion, the extrusion dynamics and intervals of excretion actions of the sputum excretion device, as well as necessary information like date and time.

While the present invention has been described in connection with preferred embodiments, it will be understood that modifications and equivalents thereof within the principles outlined above will be evident to those skilled in the art, and thus the invention is not limited to the preferred embodiments but is intended to encompass such modifications and equivalents.

What is claimed is:

1. An electromagnetic powered sputum excretion system, comprising a coughing sensor, a frequency input end, an air pressure input end, an electric-controlled switch, a timing input end, a pressure vest (80), an air vibration device (90), and a fan (70);
characterized in that said air vibration device (90) comprises stainless steel belt II (903), iron clappers (904), a housing seat (905), an electromagnet (906), and fixing bolts (907);
said electromagnet (906) is fixed within an accommodating chamber (B) in the housing seat (905); the iron clappers (904) are fixed onto the housing seat (905) via the stainless steel belt II (903), the iron clappers (904) and the accommodating chamber enclose a sealed space, and a deformation zone (A) of the iron clapper (904) is located at a position corresponding to that of the electromagnet (906); an air inlet (908) and an air outlet (909) are arranged at the position of the accommodating chamber of said housing seat (905), said air inlet (908) is connected with the fan (70), and said air outlet (909) is connected with the pressure vest (80) via a hose;
the sputum excretion system further comprises:
a storage unit (601), in which a plurality of sputum excretion plans including the start time and stop time of the sputum excretion system, the extrusion dynamics and intervals of excretion actions of the sputum excretion system are stored in advance;
a control unit (603), which is connected with the storage unit (601), and selects a specific sputum excretion plan as needed; or directly controls the start time and stop time of the sputum excretion system, the extrusion dynamics and intervals of excretion actions of the sputum excretion device;
a central processing unit (602), which is connected with said control unit (603), executes the selected sputum excretion plan, controls start and stop of the sputum excretion system, controls the extrusion dynamics and intervals of excretion actions of the sputum excretion system in the process of sputum excretion.

2. The electromagnetic powered sputum excretion system of claim 1, characterized in that said iron clappers (904) are sleeved in a rubber gasbag (902), which is fixed onto the housing seat (905) via a stainless steel belt I (901).

3. The electromagnetic powered sputum excretion system of claim 1, characterized by further comprising an input and edit unit (604), which is connected with the storage unit (601), inputs a new sputum excretion plan, edits the original sputum excretion plan, and sets a specific sputum excretion plan as a default sputum excretion plan.

4. The electromagnetic powered sputum excretion system of claim 1, characterized by further comprising a display unit (605), which displays information about the sputum excretion plan being executed by the sputum excretion device, the remaining time of the current sputum excretion, the time for the next sputum excretion, the extrusion dynamics and intervals of excretion actions of the sputum excretion device.

5. The electromagnetic powered sputum excretion system of claim 1, characterized by further comprising a learn and record unit (606), which records the process of sputum excretion in a day, and stores it as a new sputum excretion plan.
